(19) United States
(12) Patent Application Publication
(10) Pub. No.: US 2023/0211800 A1
(43) Pub. Date: Jul. 6, 2023

(54) LOW-SPEED MANEUVER ASSISTING SYSTEM AND METHOD

(71) Applicant: VINAI ARTIFICIAL INTELLIGENCE APPLICATION AND RESEARCH JOINT STOCK COMPANY, Ha Noi (VN)

(72) Inventors: Phuc Thien Nguyen, Ha Noi (VN); Duc Chan Vu, Ha Noi (VN); Chi Thanh Nguyen, Ha Noi (VN); Hai Hung Bui, Ha Noi (VN)

(21) Appl. No.: 18/092,011

(22) Filed: Dec. 30, 2022

(30) Foreign Application Priority Data
Dec. 31, 2021 (VN) 1-2021-08526

(51) Int. Cl. B60W 60/00; B60W 50/14; B60K 35/00; B60W 30/06; B60R 1/23

(52) U.S. Cl. CPC B60W 60/001; B60W 50/14; B60K 35/00; B60W 30/06; B60R 1/23; B60W 2420/00; B60K 2370/152; B60K 2370/73; B60R 2300/60; B60W 2050/146; G06F 3/0488

(57) ABSTRACT

Maneuver assisting system and method are provided. The system includes at least one processor configured to process operations of the system; one or more memories for storing instructions; a communication unit for communicating between components of the system, and between the system and the vehicle and/or a user equipment; a Surrounding View Monitoring (SVM) unit comprising a plurality of sensors for providing a plurality of vehicle-related information; a Human-Machine Interface (HMI) configured for a driver of the vehicle to interact with the system; a display unit configured to display the HMI; a motion planning unit configured to generate a trajectory for the vehicle to follow; and a motion control unit configured to control the automated maneuvers of the vehicle. In particular, the HMI is configured to be implemented in the user equipment in order for the driver to remotely operate the system using the user equipment.

### CROSS-REFERENCE TO RELATED APPLICATION

The present application claims priority from Vietnamese Application No. 1-2021-08526 filed on Dec. 31, 2021, which is incorporated herein by reference in its entirety.

### TECHNICAL FIELD

Embodiments of the invention relate to a low-speed maneuver assisting system and method for smart vehicles.

### RELATED ART

Recently, a demand for smart vehicles implementing an automotive Advanced Driver-Assistance Systems (ADAS) has rapidly increased. ADAS are groups of electronic technologies that assist drivers in driving and parking functions. Through a safe human-machine interface, ADAS increase car and road safety. ADAS use automated technology, such as sensors and cameras, to detect nearby obstacles or driver errors and respond accordingly. Adaptive features of ADAS may automate lighting, provide adaptive cruise control, assist in avoiding collisions, incorporate satellite navigation and traffic warnings, alert drivers to possible obstacles, assist in lane departure and lane centering, provide navigational assistance through smartphones, and provide other features.

Low-speed-maneuvers assist is considered as one component of ADAS. The Low-speed-maneuvers assist feature may comprise: Automated Parking (AP), Automated Parking Assist (APA), Autonomous Valet Parking (AVP), Auto Summon, etc. features that use the technologies making motion generating and motion control for the vehicle which can help the vehicle to do the act of parking-in automatically, parking-out, reverse maneuvering, turning the vehicle around, etc. However, these features are solely based on the starting position and the destination position without flexible choices for the driver. That is, the starting position and the destination position is fully recognized by these features, therefore the driver of the vehicle cannot choose these positions flexibly and can only accept or reject the proposition of these features.

Therefore, there is a need for an improved automotive low-speed-maneuvers assist system and method that is not only able to automatically propose the destination positions where the vehicle will be parked-in, parked-out, reverse maneuvered thereto, etc., but also let the driver have the flexibility to choose their desired destination positions.

### SUMMARY

The invention has been made to solve the above-mentioned problems, and an object of the invention is to provide a low-speed maneuver assisting system and method that let the driver of the vehicle choose manually desired destination positions to which the vehicle is parked/moved, beside the predetermined positions proposed by the automotive system, or choose a desired heading angle of the vehicle different from a predetermined heading angle, thereby enhancing some of the ADAS features, such as Surrounding View Monitoring (SVM), Auto Parking or Auto Summoning features.

Further, the system and method according to the disclosure can help the drivers in low-speed-maneuvers which demand high concentration and exposed to high risk of collision (with the outside objects or humans) leading to accidents or car damages. The system and method of the disclosure can help the vehicle to plan and act automatically low-speed-maneuvers such as parking-in (parallel, perpendicular, angled parking-spaces), parking-out (parallel, perpendicular, angled parking-spaces), reverse maneuvers, 3-points turn, small lateral-displacement maneuvers (side-slip maneuver) and low-speed-maneuvers at driver's frequent place (e.g., home garage). Drivers are liberated from multiple repetitive actions such as steering, throttle, braking thanks to the present invention and can focus on monitoring the surrounding during automated maneuvers.

Problems to be solved in the embodiments are not limited thereto and include the following technical solutions and also objectives or effects understandable from the embodiments.

According to the first aspect of the invention, there is provided a low-speed-maneuver assisting system having a plurality of automated maneuvering modes for automated maneuvers of a vehicle, the system comprising:

at least one processor configured to process operations of the system;

a communication unit for communicating between components of the system, and between the system and the vehicle and/or a user equipment;

a Surrounding View Monitoring (SVM) unit comprising a plurality of sensors for providing a plurality of vehicle-related information, wherein the vehicle-related information comprises a plurality of vehicle images in a plurality of views and vehicle surroundings information,

wherein the at least one processor is configured to perform a localization function for localizing the vehicle based on the vehicle surroundings information obtained from the SVM unit,

wherein the at least one processor is further configured to process the vehicle-related information to generate a top view image, the top view image comprising a top view of the vehicle and a top view of the vehicle's surroundings;

a Human-Machine Interface (HMI) configured for a driver of the vehicle to interact with the system,

wherein the HMI is further configured to display the top view image of the vehicle, wherein the vehicle is located at a starting position,

wherein the HMI is further configured to display a destination position and a heading angle of the vehicle, each of the destination position and the heading angle of the vehicle being designated by a user input from the driver;

a display unit configured to display the HMI;

a motion planning unit configured to generate a trajectory for the vehicle to follow, wherein the trajectory is generated based on the starting position, the designated destination position of the vehicle and the localization information obtained by the localization function;

a motion control unit configured to control the automated maneuvers of the vehicle, wherein the motion control unit calculates at least one of the steering, throttling, or braking of the vehicle during the automated maneuvers;

one or more memories for storing instructions to operate the low-speed-maneuver assisting modes, such that when the instructions are executed by the processor, the system performs at least one of the functions of the low-speed-maneuver assisting system;

wherein the HMI is further configured to be implemented in the user equipment in order for the driver to remotely operate the system using the user equipment. In some embodiments, the display unit is integrated in an infotainment system of the vehicle.

According to another aspect of the invention, there is provided a low-speed-maneuver assisting method, wherein the method is performed by the low-speed-maneuver assisting system in the first aspect of the disclosure, the method comprises:

obtaining, by the SVM unit, a plurality of the vehicle-related information, the vehicle-related information comprises a plurality of vehicle images in a plurality of views and vehicle surroundings information;

generating a top view image by processing the vehicle-related information obtained by the SVM unit by the processor;

localizing the vehicle, by the localization function, in order to obtain localization information based on the vehicle surroundings information obtained from the SVM unit, wherein the localization function is performed by the processor;

displaying the top view image of the vehicle in its starting position on a screen of the HMI, wherein the HMI is configured to be displayed on the display unit;

designating a destination position and a heading angle for the vehicle, wherein the destination position is chosen by the driver, the destination position and the heading angle is also displayed on the screen of the HMI;

generating a trajectory, by the motion planning unit, to be followed by the vehicle, the trajectory is generated based on the localization information obtained by the localization function;

maneuvering the vehicle with respect to the trajectory, such that the vehicle is automatically maneuvered along the trajectory to the designated destination position, wherein the automated maneuvers of the vehicle are controlled by the motion control unit;

wherein the HMI is further configured to be implemented in the user equipment in order for the driver to remotely operate the system using the user equipment.

### BRIEF DESCRIPTION OF THE DRAWINGS

The above and other objects, features, and advantages of the invention will become more apparent to those of ordinary skill in the art by describing exemplary embodiments thereof in detail with reference to the accompanying drawings, in which:

FIG. 1 is a flow diagram illustrating a low-speed-maneuver assisting system according to an aspect of the disclosure;

FIG. 2 illustrates an exemplary range of view of a Surrounding View Monitoring (SVM) unit of the system according to the aspect of the disclosure;

FIG. 3 illustrates an exemplary free slot detection result obtained by a semantic segmentation task of the SVM unit;

FIG. 4A illustrates an exemplary interactive screen of a Human-Machine Interface (HMI) of the system displaying the vehicle positions and its surroundings according to the aspect of the disclosure;

FIG. 4B illustrates an exemplary interactive screen of the HMI in the case where the constraints are preloaded to the HMI.

FIG. 5 illustrates an example of the interaction of the driver with the interactive screen of the HMI;

FIG. 6 illustrates an exemplary embodiment of the disclosure wherein the HMI is implemented in a user equipment;

FIG. 7A and FIG. 7B are examples illustrating the screen of the HMI in an automated parking-in mode and an automated parking-out mode according to an embodiment of the disclosure;

FIG. 8 shows an example of operating an automated side-slip assist mode of the low-speed maneuver assisting system of the disclosure;

FIG. 9 shows an example of operating an automated reverse maneuvering assist mode of the low-speed maneuver assisting system of the disclosure;

FIG. 10 shows an example of operating an automated turn-around maneuvering assist mode of the low-speed maneuver assisting system of the disclosure;

FIG. 11A and FIG. 11B are examples of operating an automated summon-in mode and an automated summon-out mode of the low-speed maneuver assisting system of the disclosure, respectively; and

FIG. 12 is a flow diagram illustrating a low-speed maneuver assisting method according to an aspect of the disclosure.

### DETAILED DESCRIPTION

While the invention may have various modifications and alternative forms, specific embodiments thereof are shown by way of example in the drawings and will be described herein in detail. However, there is no intent to limit the invention to the particular forms disclosed. On the contrary, the invention covers all modifications, equivalents, and alternatives falling within the spirit and scope of the appended claims.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and is not to be interpreted in an idealized or overly formal sense unless expressly so defined herein.

Hereinafter, embodiments will be described in detail with reference to the accompanying drawings, the same or corresponding components are denoted by the same reference numerals regardless of reference numbers, and thus the description thereof will not be repeated.

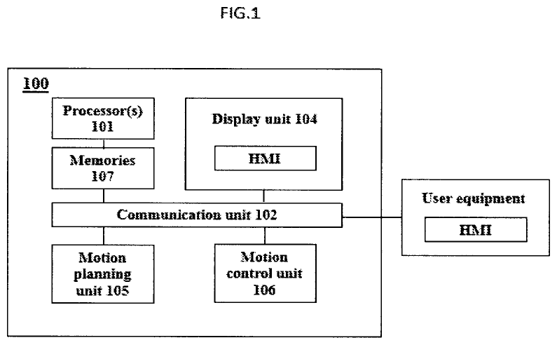

FIG. 1 is a diagram illustrating a low-speed maneuver assisting system implemented in a smart vehicle according to an aspect of the disclosure.

Refer to FIG. 1, in an embodiment of the disclosure, the low-speed maneuver assisting system 100 comprises at least one processor 101 configured to process a plurality of operations of the system 100.

The system 100 further comprises a communication unit 102 for communicating between components of the system, and between the system and the vehicle and/or user equipment. In particular, the communication unit 102 is configured to transmit and/or exchange information between components of the system 100, and between the system 100 and the vehicle, or between the system 100 and the user equipment. The information to be transmitted/exchanged may be the information necessary for a low-speed maneuver assisting mode. For example, the information may comprise a starting position of the vehicle, a target parking space for the vehicle, navigation information, information of the surrounding objects/environment of the vehicle. As another example, the information may also comprise the information of traveling direction, vehicle speed and/or acceleration, forward/backward movement of the vehicle, etc. Yet another example, the information may also comprise the outside view of the vehicle itself received from one or more sensors mounted to the outside of the vehicle.

In one embodiment, the communication unit 102 is further configured to transmit a user input by the driver from the user equipment of the driver to the system 100 or from the system 100 to the vehicle in order to operate the vehicle. The communication unit 102 may further receive location information of the vehicle, traffic information, and/or weather information of the location the vehicle is currently at from the user equipment or from a cloud server. The communication unit 102 may further send the received information to the system for processing.

In one embodiment, the communication unit 102 may be configured to communicate with the vehicle or the user equipment using wire or wirelessly. For example, the communication unit 102 may use wireless communication technology, such as Bluetooth®, Near Field Communication (NFC), ZigBee, Wi-Fi, WLAN, etc.

In one embodiment, the communication unit 102 may be configured to pair with the user equipment via the above-mentioned wireless communication technologies, via wired communication such as via USB port, or via the cloud server using a cellular network such as 2^{nd} generation (2G), 3^{rd} generation (3G), Long-term Evolution (LTE), Code Division Multi Access (CDMA), Wideband CDMA (WCDMA), High Speed Downlink Packet Access (HSDPA) networks, etc.

The system 100 further comprises a Surrounding View Monitoring (SVM) unit 103 and a display unit 104.

The SMV unit 103 comprises a plurality of sensors for providing a plurality of vehicle-related information. The vehicle-related information may comprise a plurality of vehicle images in a plurality of views and vehicle surroundings information.

In one embodiment of the disclosure, the sensors of the SVM unit 103 comprise one or more cameras. Each of the cameras may be a wide-angle camera providing the wide-angle viewing of the surrounding of the vehicle and the vehicle itself. For example, the SVM unit 103 comprises four cameras located at the front, rear, left, and right sides of the vehicle. However, the number of cameras of the SVM unit 103 is not limited thereto. The cameras of the SVM unit 103 may provide a front view, a rear view, and/or a side view of the vehicle, thereby the SVM unit is able to obtain the vehicle images in a plurality of views and the vehicle surroundings information.

In one embodiment, such views can be combined by the processor with a proper geometric alignment to provide the driver with a 360-degree view from the above in a 2D perspective, which is referred hereinbelow as a top view, or a 3D view of the vehicle, which is referred hereinbelow as a perspective view. State differently, the processor of the system 100 is configured to process the vehicle-related information obtained by the SVM unit to generate a top view image. The top view image comprises a top view of the vehicle and a top view of the vehicle's surroundings. It should be noted that the brightness and coloration of the cameras need to be adjusted to enable a consistent top view image of the vehicle and its surroundings.

In one embodiment, the display unit 104 is configured to display separately or altogether the front view, the rear view, the side view and/or the top view of the vehicle received from the SVM unit 103 via the communication unit 102.

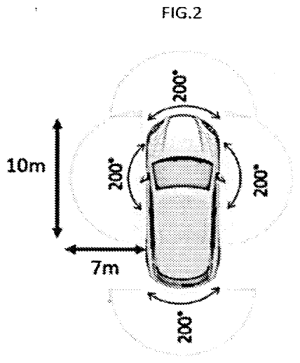

As mentioned above, each of the cameras of the SVM unit 103 is a wide-angle camera which is provided with a wide-angle lens. For example, each camera's viewing angle of the SVM unit 103 may be 200 o, as illustrated in FIG. 2, but not limited thereto, thus providing a larger range of view of the vehicle. Further, as also illustrated in FIG. 2, the SVM unit 103 creates a range of the top view with a width of 7 m and a length of 10 m from the vehicle, but not limited thereto.

The SVM unit 103 may further comprise any other type of sensors for more thorough vehicle surroundings information, such as a LiDAR sensor, a laser sensor, an ultrasonic waves sensor, and the like.

In one embodiment, the processor 101 of the system 100 may perform a semantic segmentation task on the images provided by the SVM unit 103. The semantic segmentation task is a task of clustering parts of an image together that belong to the same object class. Stated differently, it's the task of classifying each pixel of an image to each corresponding object category. Therefore, the system is capable of detecting different objects from each other, therefore this task can facilitate various automated functions of the system 100 in that the vehicle surroundings information is obtained thereby.

One of the functions of the system 100 is the free space detection function, which is performed by at least one processor of the system 100, that further analyzes the vehicle surroundings information obtained by the SVM unit to detect drivable space around the vehicle. Another function of the system 100 is the human/object detection function, which is performed by at least one processor, that also analyzes the vehicle surroundings information obtained by the SVM unit to detect humans/objects surrounding the vehicle, such as cyclists, children, adult humans, animals, cars, static/dynamic obstacles, etc. These functions may be cooperated with the semantic segmentation task of SVM unit to obtain more thorough vehicle's surroundings information.

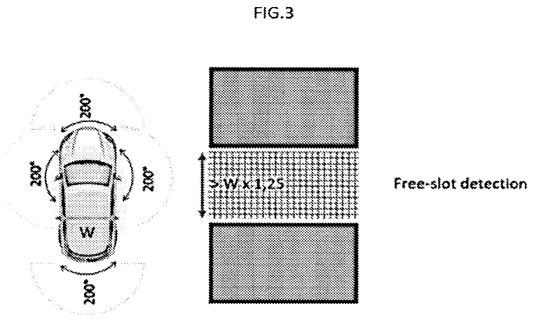

For instance, by making use of the semantic segmentation task, the system 100 may detect a free parking slot among two or more other detected vehicles for parking the vehicle, with the width of the free parking slot being more than 1.25 times of the width of the vehicle, as illustrated in FIG. 3, for example.

In another embodiment of the disclosure, each of the cameras of the SVM unit 103 may be an infrared (IR) camera that has night vision for a night mode of the system 100. Therefore, the system 100 can detect objects in low light conditions to facilitate the automated modes. The images in low light condition captured by the SVM unit 103 are processed using the semantic segmentation task for objects detection. The objects detection may be further enhanced by an Artificial Intelligence (AI) model.

In one embodiment of the disclosure, at least one processor of the system 100 is configured to perform a localization function for localizing the vehicle based on the vehicle surroundings information obtained from the SVM unit, to obtain the localization information, so as to facilitate the motion planning for the vehicle of the system 100, as will be discussed later.

In one embodiment of the disclosure, at least one processor of the system 100 is further configured to perform a mapping function for generating a map surrounding a previous trajectory of the vehicle based on the localization information obtained by the localization function, in order to further facilitate the motion planning for the vehicle of the system 100.

In one embodiment of the disclosure, at least one processor is further configured to perform a coordinates system transformation for the localization function and the mapping function.

Return to FIG. 1, the system 100 further comprises a Human-Machine Interface (HMI) configured for a driver of the vehicle to interact with the system, wherein the driver can operate at least one of a plurality of low-speed-maneuver assisting modes via the HMI. In one embodiment, the HMI may be implemented in an infotainment system of the vehicle and configured to be displayed on the display unit 104. The HMI may be in communication with the system 100 and an actuating system of the vehicle (not shown) that controls the actuation of the vehicle. The HMI may transmit and receive signals to and from the actuating system and the system 100 before and/or during the automated maneuvers of the vehicle executed by the system 100. Such signals may be used to activate/deactivate the automated maneuvers modes of the system 100, thus start/stop the actuation of the vehicle by the actuating system.

The HMI is a form of a User Interface (UI). A UI is an electronic input medium that is electrically connected to the vehicle. The UI may be connected to the vehicle through any wired connection or may be connected wirelessly to the vehicle. The interface may comprise an input unit and a display to display the interface.

The input unit may comprise any number of media that allow the driver to input data by using it, such as a mouse, keyboard, joystick, buttons, knob, touch panel, or an external device, such as a handheld device, smartphone, PDA, tablet, or voice input via a microphone, or gesture input, etc.

The display of the HMI may be the display unit 104 of the system 100. The display unit 104 may be a CRT display, a liquid-crystal display (LCD), a light-emitting diode (LED) display, an organic LED display, or any other suitable type of display. In one embodiment, the display unit 104 may be integrated in the infotainment system of the vehicle, but the disclosure is not limited thereto.

In one embodiment of the disclosure, the display unit 104 of the system 100 is a touch-input display that comprises a touch-input panel. The HMI may receive the user input via the touch-input display unit 104. In particular, the HMI may display on the display unit 104 a selection of low-speed-maneuver assisting modes for the driver to operate. The modes comprise, but not limited to: automated parking-in with or without space marking, automated parking-out with or without space marking, automated side-slipping, automated reverse maneuvers, automated turn-around maneuvers modes.

The HMI is configured to display the top view image of the vehicle, wherein the vehicle is located at a starting position. In particular, once the driver selects the automated low-speed-maneuver assisting mode, or after the driver confirms the automated mode suggestion of the system, the HMI may display an interactive screen displaying the vehicle in its starting position and its surroundings based on the top view image of provided by the SVM unit 103. This helps the driver have an overall view of the vehicle's real-time position, thus facilitating the driver to decide on the vehicle's destination.

The HMI is further configured to display a destination position and a heading angle of the vehicle, each of the destination position and the heading angle of the vehicle may be designated by a user input from the driver, according to one embodiment of the disclosure.

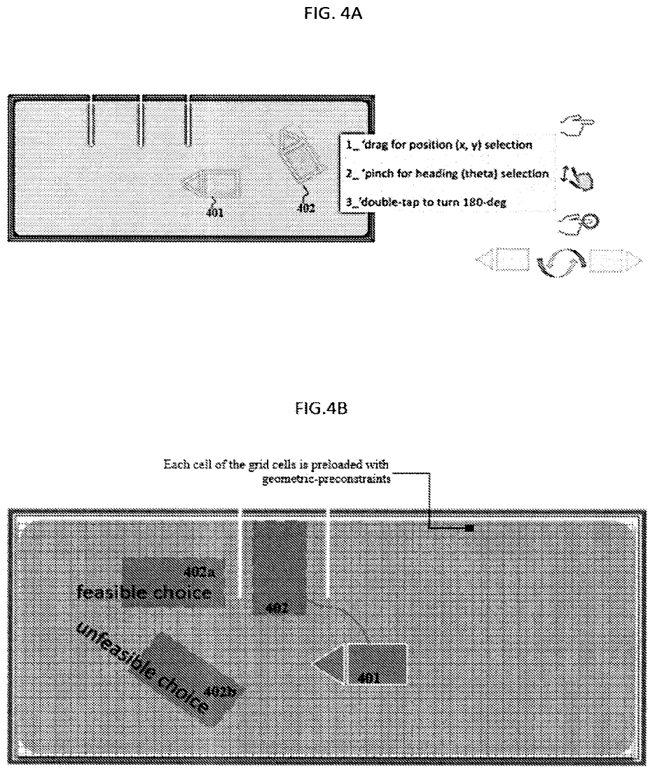

Refer to FIG. 4A illustrating an exemplary interactive screen of the HMI displaying the vehicle positions and its surroundings. In particular, the screen displays the vehicle in its starting position 401, wherein the starting position 401 is the real-time position of the vehicle. The screen also displays a destination position 402 and a heading angle of the vehicle.

In one embodiment, the destination position 402 is automatically suggested by the system 100 in FIG. 1. To achieve this, at least one processor of the low-speed-maneuver assisting system is further configured to perform a parking space detection function. The parking space detection function is a function based on the vehicle's surroundings information obtained by the SVM unit. To this end, the low-speed-maneuver assisting system may suggest available parking spaces in the screen of the HMI on the display unit.

In another embodiment, the destination position 402 of the object of the vehicle may be chosen by the driver. The display unit in this embodiment is a touch-input display. The user input is input to the HMI by the driver by using touch gestures on the display unit of the system. For example, the driver may use one finger to touch the object 402 displayed on the screen indicating the destination position, and drag the object to move the destination position 402 to a desired position on the screen. The destination position 402 may be moved in the Cartesian coordinate system.

The driver can further choose a heading angle of the vehicle in the destination position 402 with touch gestures. For example, the driver may use two fingers to touch and pinch the object to rotate the object in the polar coordinate system, the object herein indicates the destination position 402 of the vehicle, thereby adjusting the heading angle of the vehicle in the destination position 402.

As another example, the driver may double tap on the object in order to turn the object 180 o the object herein indicates the destination position 402.

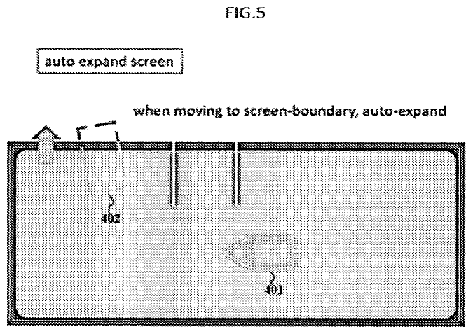

As another example, as illustrated in FIG. 5, when the driver moves the object to the screen boundary, that is, the desired position for the destination position 402 chosen by the driver may outcross the current displaying range on the screen, the screen may automatically expand to include the whole object in such destination position. The object herein indicates the destination position 402.

The destination position and heading angle of the vehicle may be freely chosen by the driver, but they are constrained by at least one of safety conditions, ranges of the sensors of the SVM unit, vehicle kinematic limitations, vehicle dynamic limitations, motion control limitations, or system designs based on predefined use-cases. These constraints are referred to as geometric pre-constraints, which are preloaded to the HMI to filter out infeasible destination poses of the vehicle, and are defined by: position constraint, heading angle constraint by a trajectory planner, free-space constraint by a free-space detection function and use-case constraint. Thus, the driver cannot choose destination positions and heading angles of the vehicle that are filtered out by these pre-constraints.

Referring to FIG. 4B which illustrates an exemplary interactive screen of the HMI in the case where the above-mentioned constraints are preloaded to the HMI. For example, the HMI is the HMI 103 of the system 100 in FIG. 1.

In one embodiment of the disclosure, similar to the above-discussed embodiment with reference to FIG. 4A, the destination position of the vehicle may be auto-suggested by the system 100 such as, for example, the destination position 402 as illustrated in FIG. 4B, or may be manually chosen by the driver. However, the desired destination position chosen by the driver, such as the position 402b for example, may be considered an infeasible choice by the system 100 and may be not accepted by the system 100. The system 100 may consider whether or not a position chosen by the driver is a feasible choice for the destination position of the vehicle based on the above-discussed constraints and by implementing the above-discussed constraints to the HMI. To this end, the screen of the HMI may be divided into a plurality of cells using an invisible grid which is invisible to the driver. Each cell of the grid cells is preloaded with the above-mentioned pre-constraints, in order to help the system to precisely filter out the infeasible choices for the destination position of the vehicle, such as the position 402b.

Once the driver has chosen the desired position to be the destination position for the vehicle, which is considered a feasible choice for the destination position by the system 100, such as the position 402a as illustrated in FIG. 4B, the system may activate at least one of the automated maneuvering mode for automated maneuvers of the vehicle to the desired destination position.

In one embodiment of the disclosure, the HMI is further configured to be implemented in a remote device. The remote device may be a user equipment of the driver. By using the HMI implemented in the user equipment, the driver can activate the automated maneuvers modes of the low-speed maneuver assisting system or manually maneuver the vehicle when the driver is either inside or outside of the vehicle. This will be effective and convenient for the driver in most cases as the driver does not have to be inside of the vehicle to operate the low-speed maneuver assisting system.

The user equipment may be any suitable type of portable device that is carried by the driver and is capable of receiving and transmitting signals for operating the low-speed maneuver assisting system, such as: a smartphone, tablet, PDA, laptop, portable media player, or the like. In one embodiment of the disclosure, the user equipment is provided with a touch-input display in order to input the user input by using touch gestures.

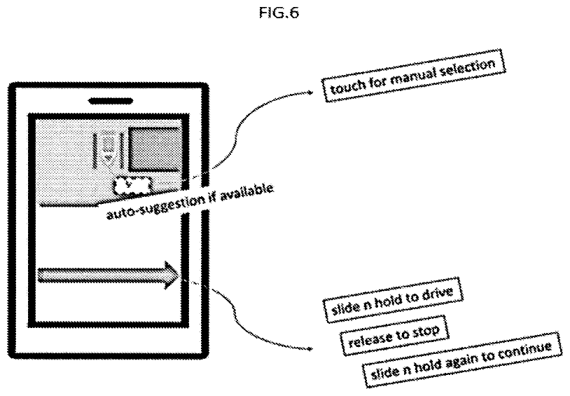

Refer to FIG. 6, which illustrates an exemplary embodiment of the disclosure wherein the HMI is implemented in a user equipment in addition to the HMI implemented in the vehicle's infotainment system, and both are in communication with each other by using the communication unit, for example, the communication unit 102 in FIG. 1. The HMI may be implemented in the user equipment in the form of a program or an application installed to the user equipment. The HMIs implemented in the vehicle's infotainment system and in the user equipment may function simultaneously.

The interactive screen of the HMI in the user equipment may be the same as that in FIG. 4A, and is displayed on the display of the user equipment, where the driver can choose the automated maneuvers modes and choose the destination and heading angle of the vehicle in the same manner as discussed above.

In another embodiment, the interactive screen may be divided into an upper half and a lower half. The upper half may represent the vehicle in its real-time and destination positions and its surroundings that are similar to the HMI screen displayed on the display unit of the infotainment system of the vehicle. The lower half of the screen may be a touch-input zone where the driver can use touch gestures to maneuver the vehicle manually.

In the upper half of the screen, the low-speed maneuver assisting system may automatically suggest a destination position of the vehicle for the driver and display the destination position on the screen. The destination position may be displayed as a rectangle space marking, for example. The driver may then accept the autosuggestion and activate the automated maneuvers function of the low-speed maneuver assisting system. Or the driver may not accept the autosuggestion and may choose their desired destination position and heading angle of the vehicle manually. The driver's operations to select automated maneuvering modes, choose the destination position and/or the heading angle of the vehicle are the same as those described in FIG. 4A to FIG. 5, therefore detailed descriptions thereof will be omitted for the sake of clarity.

In the lower half of the screen, the driver can manually maneuver the vehicle by touch gestures in automated maneuvering modes such as the remote vehicle maneuvering mode. For example, the driver can touch with one finger, then slide and hold any point in the touch zone, and then slide across the touch zone to drive the vehicle in the current heading direction of the vehicle, and then release the finger from the display to stop the vehicle. The driver may perform the touch, hold and slide action again to continue driving the vehicle.

Once the driver has confirmed their desired destination position and/or heading angle for the vehicle thereby confirming a destination position and the heading angle setting in the HMI, the low-speed maneuver assisting system may transmit an actuating control signal to the actuating system of the vehicle to perform automated maneuvering modes.

An automated maneuvering mode is provided by the low-speed maneuver assisting system that can manipulate the actuating system of the vehicle and automatically drives the vehicle to the desired destination position by designing a trajectory for the vehicle to follow according thereto, such that the vehicle can automatically travel to the destination position in a safe manner.

Refer back to FIG. 1, the low-speed maneuver assisting system further comprises

a motion planning unit configured to generate a trajectory for the vehicle to follow, wherein the trajectory is generated based on the starting position, the designated destination position of the vehicle and the localization information obtained by the localization function.

The low-speed maneuver assisting system further comprises a motion control unit configured to control the automated maneuvers of the vehicle, wherein the motion control unit calculates at least one of the steering, throttling, or braking of the vehicle during the automated maneuvers. Therefore, the driver is released from multiple repetitive actions by virtue of the motion control unit

The low-speed maneuver assisting system further comprises one or more memories for storing instructions to operate the low-speed maneuver assisting system, such that when the instructions are executed by the processor, the system performs at least one of functions of the system 100.

The memory suitable for storing instructions and data in the disclosure comprises all forms of non-volatile memory, media and memory devices, including, by way of example, semiconductor memory devices, e.g., Random Access Memory (RAM), Read-only Memory (ROM), erasable programmable ROM (EPROM), Electrically Erasable Programmable ROM (EEPROM), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

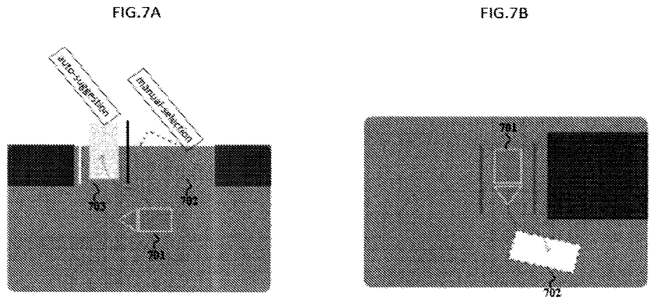

FIG. 7A and FIG. 7B are examples showing the HMI screens in an automated parking-in mode and an automated parking-out mode, respectively, with an image 701 indicating the vehicle in its real-time position and direction, according to one embodiment of the disclosure.

Refer to FIG. 7A, when the low-speed maneuver assisting system, for example, the low-speed maneuver assisting system 100 in FIG. 1, detects a free parking space by the parking space detection function, the low-speed maneuver assisting system may automatically suggest such parking space to the driver by displaying in the HMI screen the space marking 703 indicating the suggested parking space.

Assume that the driver accepts the free parking space suggested by the low-speed maneuver assisting system. In this case, the system may then activate the automated parking-in mode, in which the system automatically plans a trajectory which the vehicle can follow by the above-discussed motion planning unit of the system 100. The trajectory is generated based on the starting position of the vehicle, which is the real-time position 701, and the destination position, which is the suggested free parking space. Then, the system automatically maneuvers the vehicle to the destination position using the above-discussed motion control unit.

Otherwise, if the driver does not accept the autosuggestion of the system, the driver may then manually choose their desired destination position and heading angle for the vehicle by using touch gestures as described above with reference to FIG. 4A to FIG. 5. Similar to the above, when the driver confirms the vehicle's destination position and heading angle, the low-speed maneuver assisting system may then activate the automated parking-in mode and automatically maneuvers the vehicle to the destination position using the same operations as above.

Refer to FIG. 7B, the similar operations as described with reference to FIG. 7A are performed to park out the vehicle, except that the starting position 701 of the vehicle is the parking position, and the destination position 702 is the park-out position, wherein the park-out position is either automatically suggested by the low-speed maneuver assisting system or chosen by the driver. The system may then activate the automated parking-out mode to maneuver the vehicle to the destination position automatically.

The low-speed maneuver assisting system according to the disclosure may perform a precise automated-parking-in and parking-out mode with or without a space marking.

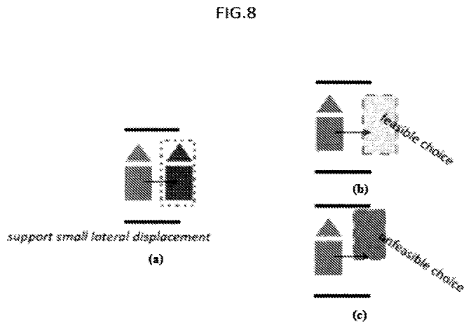

In FIG. 8, case (a) shows an example of operating an automated side-slip assist mode of the low-speed maneuver assisting system of the disclosure, wherein the system is capable of performing a small lateral displacement maneuver for the vehicle.

Conventionally, the act of performing the small lateral displacement maneuver is tricky and needs precise and repetitive maneuvers from the driver, such as steering, throttling, braking. With the low-speed maneuver assisting system, the driver is released from such repetitive maneuvers. In particular, with enough information obtained from the localization function and precise control from the motion control unit, the low-speed maneuver assisting system can filter out the infeasible choices (as in case (c) in FIG. 8) and automatically side-slip maneuver the vehicle to a feasible destination position (as in case (b) in FIG. 8). The operations of the automated side-slip assist mode are similar to those of the automated parking mode, therefore detailed descriptions thereof will be omitted.

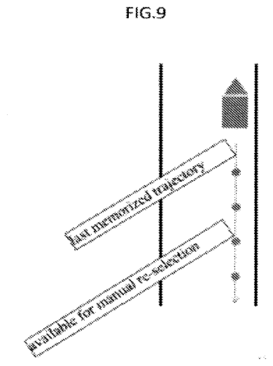

FIG. 9 shows an example of operating an automated reverse maneuvering assist mode of the low-speed maneuver assisting system of the disclosure, wherein the system is capable of automatically reverse maneuvering the vehicle. The system may cause the vehicle to automatically travel reversely with respect to the last trajectory, which was previously generated by the above-discussed motion planning unit. The driver may otherwise choose the desired destination position for the vehicle by using touch-gestures input as discussed above.

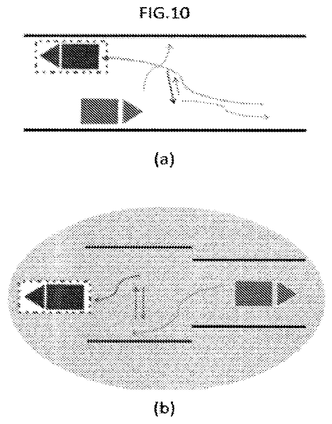

FIG. 10 shows an example of operating an automated turn-around maneuvering assist mode of the low-speed maneuver assisting system of the disclosure, wherein the system is capable of maneuvering the vehicle such that the vehicle turns around. The system may assist the driver to turn around the vehicle using 3-point-turn manner (as in (a) in FIG. 10) or turn around the vehicle in a narrow place (as in (b) in FIG. 10). Similar to the above discussion, the destination position and/or the heading angle of the vehicle may be either suggested by the low-speed maneuver assisting system or manually chosen by the driver.

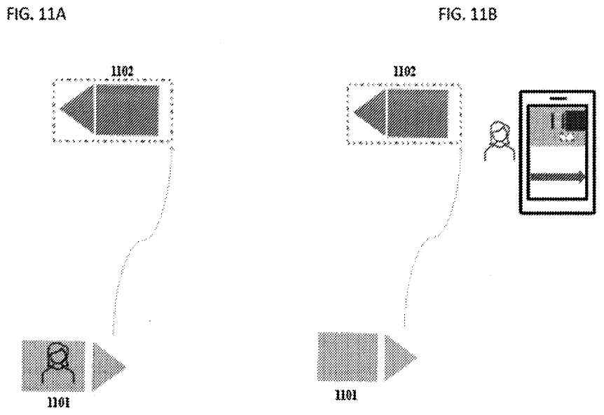

FIG. 11A and FIG. 11B are examples of operating an automated summon-in mode and an automated summon-out mode of the low-speed maneuver assisting system of the disclosure, respectively.

Refer to FIG. 11A, in one embodiment of the disclosure, the driver may stay in the vehicle and use the touch-input display of the infotainment system of the vehicle, in which the HMI of the low-speed maneuver assisting system is integrated, to use the automated summon-in mode. The driver may then choose a designated destination position 1102 on the HMI screen. Once the designated destination position is confirmed, the low-speed maneuver assisting system may activate the automated summon-in mode. The system may automatically plan a trajectory from the starting position 1101 of the vehicle to the designated destination position 1102 by the motion planning unit of the system, and automatically maneuver the vehicle to the designated destination position 1102.

Refer to FIG. 11B, in one embodiment of the disclosure, the driver may stay in place outside of the vehicle and use the HMI implemented in the user equipment of the driver to use the automated summon-out mode in order to summon the vehicle from a starting position 1101. The starting position of the vehicle 1101 may be a parking space or any free space that the vehicle is parked at. The starting position 1101 should be within line of sight of the driver. Once the driver confirms the designated destination position for the vehicle, which may be near the driver's current position, the system may activate the automated summon-out mode. Similar to the automated summon-in mode, the system may automatically plan a trajectory from the starting position 1101 of the vehicle to the designated destination position 1102 by the motion planning unit of the system, and automatically maneuver the vehicle to the designated destination position 1102.

These automated summon-in and summon-out modes are applicable to the case of performing the maneuvers of the vehicle at frequent places, such as a home garage, in order to get the vehicle inside or outside of the garage conveniently.

Besides the automated maneuvers of the system in the automated maneuvers modes with reference to FIG. 7A to FIG. 11, the driver may manually control the vehicle's driving in the planned trajectory by using the touch gestures zone 1104 on the HMI screen that is both implemented in the infotainment system of the vehicle and in the user equipment, as discussed above with reference to FIG. 6. For example, the driver may manually start/stop the vehicle's planned trajectory to avoid sudden collisions with the objects/humans that suddenly cross the planned trajectory when the vehicle is being automatically driven.

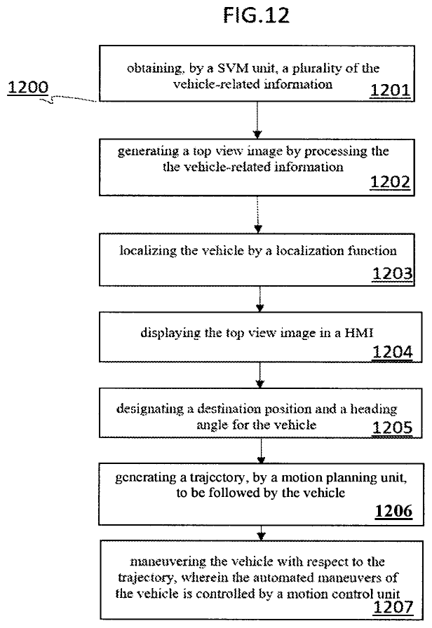

FIG. 12 is a flow diagram illustrating a low-speed maneuver assisting method 1200 according to an aspect of the disclosure. For convenience, the method 1200 will be described as being performed by a low-speed maneuver assisting system, for example, the low-speed maneuver assisting system 100 with reference to FIG. 1.

First, step 1201 is the step of obtaining, by a SVM unit, a plurality of the vehicle-related information, the vehicle-related information comprises a plurality of vehicle images in a plurality of views and vehicle surroundings information. For example, the SVM unit is the SVM unit 103 of the low-speed maneuver assisting system 100. The SVM unit 103 is described in detail above with reference to FIG. 1, so the description thereof is omitted herein for brevity.

Next, step 1202 is the step of generating a top view image by processing the vehicle-related information obtained by the SVM unit by a processor, the top view image comprises a top view of the vehicle and a top view of the vehicle's surroundings. For example, the processor may be the processor 101 of the system 100.

Next, step 1203 is the step of localizing the vehicle, by a localization function, in order to obtain localization information based on the vehicle surroundings information obtained from the SVM unit. The localization function may be performed by the processor such as the processor 101 of the system 100, for example.

Next, step 1204 is the step of displaying the top view image in a HMI, the HMI is configured to be displayed on a display unit of the low-speed maneuver assisting system. The top view image displayed on the display unit shows the vehicle in its starting position. The starting position of the vehicle is the current real-time position of the vehicle. The display unit may be the display unit 104 of the system 100. In one embodiment, the display unit of the system is the display unit of the infotainment system of the vehicle.

In one embodiment, the HMI may be implemented in both the vehicle's infotainment system and the user equipment of the driver.

Next, step 1205 is the step of designating a destination position and a heading angle for the vehicle, wherein the destination position is chosen by the driver. The destination position and the heading angle is also displayed on the HMI on the display unit, in the form of a rectangle marking, for example. In one embodiment, the display unit of the low-speed maneuver assisting system is a touch-input display, thus the driver may then use touch gestures on the display unit to choose the destination position and the heading angle for the vehicle.

In another embodiment, the destination position and heading angle of the vehicle may be automatically suggested by the low-speed maneuver assisting system, based on a parking space detection function.

Next, step 1206 is the step of generating a trajectory, by a motion planning unit, to be followed by the vehicle. The trajectory planning function may be implemented in the low-speed maneuver assisting system, such as the above-described system 100, for example. The trajectory is planned based on the starting position, the destination position, the heading angle of the vehicle.

Further, the trajectory is generated based on the localization and mapping information, which is obtained by the localization and mapping functions. The localization and mapping functions may be implemented in the low-speed maneuver assisting system, such as the above-described system 100, for example.

Finally, step 1207 is the step of maneuvering the vehicle with respect to the trajectory, such that the vehicle is automatically maneuvered along the trajectory to the designated destination position, wherein the automated maneuvers of the vehicle are controlled by a motion control unit. The motion control unit may be implemented in the low-speed maneuver assisting system, such as the above-described system 100, for example.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be a machine-readable storage device, a machine-readable storage substrate, a random or serial access memory device, or a combination of one or more of them.

The term “processor” refers to data processing hardware and encompasses all kinds of apparatus, devices, and machines for processing data, including by way of example, a programmable processor, a computer, or multiple processors or computers. The apparatus can also be or further include special purpose logic circuitry, e.g., an FPGA (field-programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other units suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Devices suitable for the execution of a program or an application include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A maneuver assisting system having a plurality of automated maneuvering modes for automated maneuvers of a vehicle, the system comprising:
at least one processor configured to process operations of the system;
one or more memories for storing instructions which, when executed by the processor, cause the system to perform at least one of functions of the maneuver assisting system;
a communication unit for communicating between components of the system, and between the system and the vehicle and/or a user equipment;
a Surrounding View Monitoring (SVM) unit comprising a plurality of sensors for providing a plurality of vehicle-related information, wherein the vehicle-related information comprises a plurality of vehicle images in a plurality of views and vehicle surroundings information;
a Human-Machine Interface (HMI) configured for a driver of the vehicle to interact with the system; and
a display unit configured to display the HMI,
wherein the at least one processor is configured to:
generate localization information by performing a localization function for localizing the vehicle based on the vehicle surroundings information obtained from the SVM unit; and
process the vehicle-related information to generate a top view image, the top view image comprising a top view of the vehicle and a top view of the vehicle's surroundings;
wherein the HMI is configured to:
display the top view image of the vehicle, wherein the vehicle is located at a starting position; and
display a destination position and a heading angle of the vehicle, each of the destination position and the heading angle of the vehicle being designated by a user input from the driver,
wherein the system further comprises:
a motion planning unit configured to generate a trajectory for the vehicle to follow, wherein the trajectory is generated based on the starting position, the designated destination position of the vehicle and the localization information obtained by the localization function; and
a motion control unit configured to control the automated maneuvers of the vehicle, wherein the motion control unit calculates at least one of steering, throttling, or braking of the vehicle during the automated maneuvers, and
wherein the HMI is further configured to be implemented in the user equipment in order for the driver to remotely operate the system using the user equipment.

2. The maneuver assisting system of claim 1, wherein each of the destination position and the heading angle of the vehicle is constrained by constraints comprising at least one of: safety conditions, ranges of the sensors of the SVM unit, vehicle kinematic limitations, vehicle dynamic limitations, motion control limitations, or system designs based on predefined use-cases.

3. The maneuver assisting system of claim 2, wherein each of the constraints is included into the HMI.

4. The maneuver assisting system of claim 1, wherein the at least one processor is further configured to perform a free-space detection function for further analyzing the vehicle surroundings information obtained by the SVM unit.

5. The maneuver assisting system of claim 1, wherein the plurality of automated maneuvering modes comprise one or more of side slipping, three-point turning, turning around, or summoning in.

6. The maneuver assisting system of claim 5, wherein the system performs the parking-in and parking-out modes without a space marking.

7. The maneuver assisting system of claim 3, wherein the display unit is a touch-input display that allows the driver to interact with the system to choose destination position and heading angle based on the constraints.

8. The maneuver assisting system of claim 7, wherein the user input is input to the HMI by the driver by using touch gestures on the display unit of the system.

9. The maneuver assisting system of claim 8, wherein the touch gestures comprise: one or more gestures of touching with one finger to choose an object, dragging with one finger, pinching with two fingers to rotate the object, or double-tapping to turn the object 180-degree.

10. The maneuver assisting system of claim 9, wherein the driver chooses the destination position and the heading angle of the vehicle on the display unit by using the touch gestures.

11. The maneuver assisting system of claim 1, wherein the user equipment comprises a touch-input display to display the HMI.

12. The maneuver assisting system of claim 11, wherein the vehicle is manually maneuvered using the user input to the HMI implemented in the user equipment.

13. The maneuver assisting system of claim 12, wherein the user input is input to the HMI by the driver by using touch gestures on the display of the user equipment.

14. A maneuver assisting method, the method comprising:
obtaining, by a Surrounding View Monitoring (SVM) unit, a plurality of vehicle-related information, the vehicle-related information comprising a plurality of vehicle images in a plurality of views and vehicle surroundings information;
generating a top view image by processing the vehicle-related information obtained by the SVM unit;
localizing the vehicle, by a localization function, in order to obtain localization information based on the vehicle surroundings information obtained from the SVM unit;
displaying the top view image of the vehicle in a starting position thereof on a Human-Machine Interface (HMI), wherein the HMI is configured to be displayed on a display unit;
designating a destination position and a heading angle for the vehicle, wherein the destination position is chosen by a driver, the destination position and the heading angle is displayed on the HMI;
generating a trajectory, by a motion planning unit, to be followed by the vehicle, the trajectory being generated based on the localization information obtained by the localization function; and
maneuvering the vehicle with respect to the trajectory, such that the vehicle is automatically maneuvered along the trajectory to the designated destination position, wherein the automated maneuvers of the vehicle are controlled by a motion control unit,
wherein the HMI is configured to be implemented in a user equipment in order for the driver to remotely operate the system using the user equipment.
